(19) United States
(12) Patent Application Publication
(10) Pub. No.: US 2014/0033113 A1
(43) Pub. Date: Jan. 30, 2014

(54) METHOD AND APPARATUS FOR CREATING A RECORD

(71) Applicants: Aleksandar Joksimovic, Singapore (SG); Althea Umali, Singapore (SG)

(72) Inventors: Aleksandar Joksimovic, Singapore (SG); Althea Umali, Singapore (SG)

(73) Assignee: YOKOGAWA ELECTRIC CORPORATION, Tokyo (JP)

(21) Appl. No.: 13/561,308

(22) Filed: Jul. 30, 2012

(51) Int. Cl. G06F 3/048

(52) U.S. Cl. 715/780

(57) ABSTRACT

A method and apparatus for creating a record, the method comprising: selecting a point on a screen image, the screen image being displayable on a display device; obtaining input through an interface; creating a record for containing the input; associating the created record with the selected point; activating a predefined event based on the input of the created record; and storing the created record in a memory.

### FIELD OF THE INVENTION

The present invention relates to a method and apparatus for creating a record, in particular, for creating a record associated with a selected point on a screen image displayed on a display device.

### BACKGROUND

In process control implementations, it is possible to get information or to infer conclusions on a current state of a control system by observing the processes involved on different screen images displayed on a display device or on different display devices. For instance, it could be determined whether the control system is behaving according to initial assumptions and predefined settings made or it is behaving with anomalies or unexpected deviations.

Different screen images allow different information relating to the state of the control system to be monitored on separate screen images. While monitoring, various situations can be identified from the different screen images. Some situations will be more important on certain screen images than situations on other screen images.

After a situation is identified, reports or information relating to it are usually recorded into a general record. The general record could be created via a text editing application. The text editing application could be part of the software of the control system. In the general record, one will try to describe and explain what has happened and what the record represents, and explain the context and observation, which have led to the record creation.

After the record creation, if one requires a copy of the screen image where the situation is identified for future reference, one usually has to perform a screen image capture of the screen image and save it as a picture file. To retrieve the screen image capture for reference, one has to look for the picture file. This looking process can be quite cumbersome.

Furthermore, if the record contains important information, one has to take initiative to alert the persons involved or take action in response to the important information. This can be a hassle as well.

### SUMMARY

In accordance with one aspect of the present invention, there is provided a method for creating a record, the method comprising: selecting a point on a screen image, the screen image being displayable on a display device; obtaining input through an interface; creating a record for containing the input; associating the created record with the selected point; activating a predefined event based on the input of the created record; and storing the created record in a memory.

The method may comprise creating a note for displaying on a second screen image, and the note being selectable for displaying the created record.

The second screen image may be the screen image, and the created note may be for displaying at the selected point on the screen image.

The second screen image may be displayable on the display device or another display device.

The note may be displayed as an attachment to an entity associated with the selected point.

The method may comprise displaying the screen image through a trigger in the displayed record.

The method may comprise displaying information of an entity associated with the created record through a trigger in the displayed record.

The method obtaining input from the interface may comprise obtaining a level of importance associated with the created record.

The method may comprise searching for the created note based on a level of importance associated with the created record using a search engine.

The method may comprise displaying the created record by selecting the created note from a screen image comprising one or more notes.

Activating a predefined event based on the input of the created record may comprise sending a message electronically to one or more devices.

The selected point may be an object in a Gantt chart.

In accordance with another aspect of the present invention, there is provided an apparatus for creating a record, the apparatus comprising: a display device for displaying a screen image; an interface for obtaining input; and a processing unit configured for enabling selection of a point on the screen image, creating a record for containing the input, associating the created record with the point selected on the screen image, activating a predefined event based on the input of the created record; and storing the created record in a memory.

The processing unit may be configured for creating a note for displaying on a second screen image, and the note may be selectable for displaying the created record.

The second screen image may be the screen image, and the created note may be for displaying at the selected point on the screen image.

The second screen image may be displayable on the display device or another display device.

The note may be displayed as an attachment to an entity associated with the selected point.

The created record may comprise a trigger for displaying the screen image.

The created record may comprise a trigger for displaying information of an entity associated with the created record.

The input may comprise a level of importance associated with the created record.

The processing unit may be configured for enabling searching for the created note based on a level of importance associated with the created record using a search engine.

The processing unit may be configured for enabling display of the created record through selection of the created note from a screen image comprising one or more notes.

The predefined event may comprise sending a message electronically to one or more devices.

The selected point may be an object in a Gantt chart.

In accordance with yet another aspect of the present invention, there is provided a machine-readable medium, having stored thereon machine-readable instructions for executing, in a machine, a method for creating a record, the method comprising: selecting a point on a screen image, the screen image being displayable on a display device; obtaining input through an interface; creating a record for containing the input; associating the created record with the selected point; activating a predefined event based on the input of the created record; and storing the created record in a memory.

### BRIEF DESCRIPTION OF THE DRAWINGS

Embodiments of the invention will be better understood and readily apparent to one of ordinary skill in the art from the following written description, by way of example only and in conjunction with the drawings, in which:

FIG. 1 is a flowchart illustrating a manual prior art procedure for creating a record.

FIG. 2 is a flowchart illustrating a manual prior art procedure for seeking information relating to a screen image from a record.

FIG. 3 is a flowchart illustrating a method for creating a record according to an example of the present invention.

FIG. 4 is a flowchart illustrating how a note is created according to an example of the present invention.

FIG. 5 is a flowchart illustrating a search process to locate notes.

FIG. 6 is a diagram illustrating four screen images displayable by an apparatus according to an example of the present invention.

FIG. 7 is a diagram illustrating interaction between components of a method and an apparatus according to an example of the present invention.

FIG. 8 is a diagram illustrating an example of architecture of an apparatus according to an example of the present invention.

### DETAILED DESCRIPTION

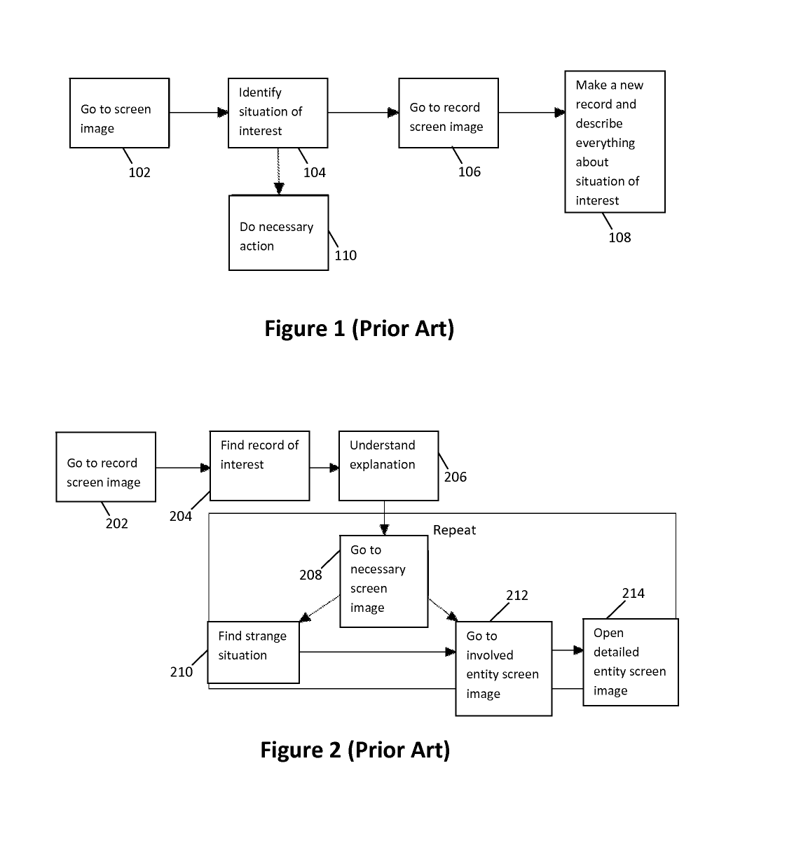

FIG. 1 illustrates a manual prior art procedure for creating a record on a computer with a display device and a graphical user interface for creating the record. It is manual in the sense that a user has to proactively go through the procedure, which is rather cumbersome. The display device is displaying a screen image containing a situation that is of interest to a user.

At step 102, a user selects on the computer to go to the screen image.

When the display device shows the selected screen image, the user identifies a situation of interest at step 104.

Upon identifying the situation of interest, the user evaluates the situation and decides whether any necessary actions need to be carried out. The user usually evaluates the situation based on its nature, and based on entities relating to the situation that are involved. At step 110, the necessary actions are performed.

During or after the actions are carried out at step 110, or if no necessary actions need to be performed, the user can navigate or go to a record screen image at step 106.

The record screen image is typically a graphical user interface for the user to make a new record at step 108. When making a new record, the user will try to explain and describe everything about the situation of interest.

FIG. 2 illustrates a manual prior art procedure for seeking information relating to a screen image from a record. It is manual in the sense that a user has to proactively go through the procedure, which is rather cumbersome.

At step 202, a user seeking information relating to a screen image from a record navigates to a record screen image. The record screen image shows a list of records.

After step 202, the user finds a record of interest from the list of records at step 204.

At step 206, the user reads the record found and understands the situation (s) recorded in the record. From the explanation in the record, the user determines which screen image or screen images are possibly linked to those situation (s).

After determining a screen image, which contains a cause for raising the situation, the user navigates to the screen image at step 208. In most cases of strange or abnormal situations, a few different entities that are displayed or mentioned in the screen image and is relating to the situation will be involved. The user may need to go through the details of each entity to investigate or inspect the situation. To do that, the user may be required to search for another screen image containing the details of each entity of interest at step 212. When the screen image containing details of the entity is found through the search, the user would open the screen image for investigation or inspection at step 214.

Steps 208, 210, 212 and 214 would be repeated for all the screen images found to be linked to the situation (s) of interest understood from the record at step 206.

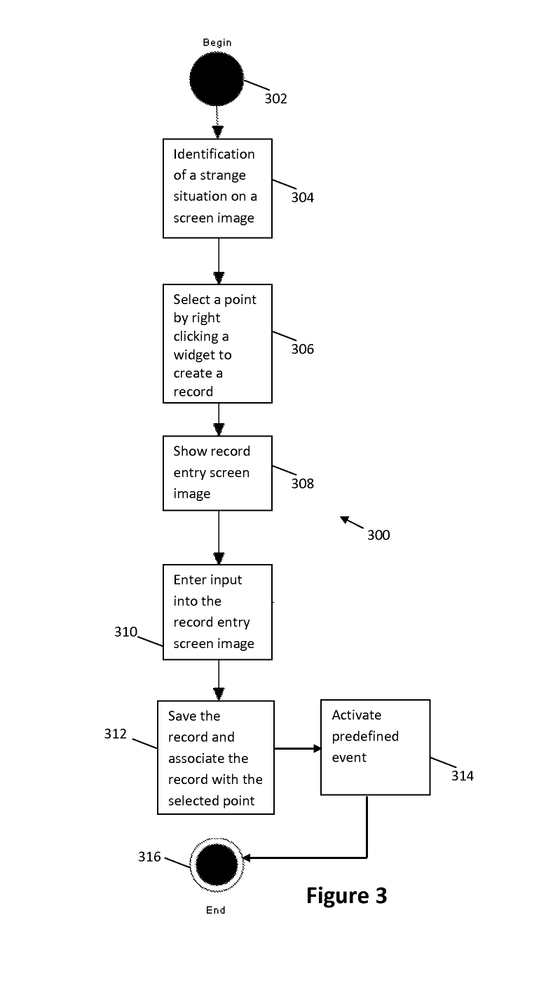

FIG. 3 illustrates a method 300 for creating a record through an apparatus. The apparatus comprises a display device for displaying a screen image, an interface for obtaining input, and a processing unit configured for various actions. The various actions include enabling selection of a point on the screen image, creating a record for containing the input, associating the created record with the point selected on the screen image, activating a predefined event based on the input of the created record, and storing the created record in a memory.

The apparatus could be a desktop computer or server, or a mobile device such as a mobile phone, a tablet computer, a laptop, and the like.

The display device could be any standard display device capable of displaying the screen image. It could be based on technologies such as, Cathode Ray Tube (CRT), Liquid Crystal Display (LCD), Light Emitting Diode (LED), Plasma, including all their variants, and the like. The screen image may be a full or partial view of a graphical user interface (GUI), a window of a GUI, a command prompt screen image, a form containing field entries, and the like.

The interface may be a GUI shown on the screen image that is configured to operate with a hardware connected to an input/output interface of the apparatus to allow input to be provided via the GUI. The hardware may be, for example, an electronic writing pad, a game pad, a remote controller, wired controller, keypad, keyboard, computer mouse, and the like. The interface may be a GUI configured to operate with the screen image in the case when the display is a touch screen. The interface could also be the hardware as mentioned alone or in combination. Furthermore, it is appreciated that the interface could cover a GUI that is web or internet based where the apparatus is a device connected to a computer network, or a GUI residing in a local device like a local desktop computer that is not part of a computer network.

The input obtained may include data based on user selection(s) of selectable object(s)/widget(s) available in the GUI. The selectable object(s)/widget(s) includes, for example, an item in a drop down box/list/menu or combo box, option buttons/switches for selecting certain object or settings, radio buttons, check box or tick box, and the like. The input may also include source code, assembly code, binary data, text data, picture data, video data or audio data, and the like. The input may not be directly obtained from a user using the interface but could also be obtained from a software application, or from a device connected to the apparatus wirelessly or otherwise.

The memory could be a local database connected to the apparatus internally or externally, a remote database connected via a computer network to the apparatus, and the like. The memory may be volatile or non-volatile memory and could be stored in magnetic or optical devices, and the like.

The method 300 relates to the creation of a record in a process control system through a GUI. The steps of the method 300 are as follows.

At step 302, the method 300 begins.

At step 304, a user who is observing a screen image identifies a potential problem i.e. a strange situation on the screen image in a display device. The screen image contains a plurality of system entities in the form of widgets or objects, which are graphically represented or represented in text format, on the screen image. The screen image could, for instance, be showing graphical representations of sensors used in factory automation. The graphical representations may be animated to display different states (e.g. switched on or off, in error, etc.) of the sensors. In this case, each sensor is a system entity.

After identifying the strange situation, at step 306, the user selects a point on a screen image by, for instance, right clicking on the appropriate widget or object representing a system entity that is of interest or that is causing the strange situation. For example, in the case where the system entity is a sensor in a factory, the sensor is found to be in error and is not working properly. By selecting the point, it is indication that a record is to be created.

In the present example, after step 308, a record entry screen image appears in the display device. The record entry screen image, which will be a graphical representation of the record, is created or generated by a computer program of the GUI. User input can be obtained through the record entry screen image.

The record entry screen image contains text boxes for entering text relating to the strange situation. There could be text boxes for entering a serial number for the record, a record title or header, and/or brief description or explanation of the situation (s) of interest. The record entry screen image may include buttons, hyperlinks or triggers selectable for saving the record, to exit the record entry screen image to cancel record creation, and/or to display another screen image or go to another screen image.

The record entry screen image may also contain selectable object(s)/widget(s) for selecting a level of importance of the situation and a portion allowing one or more identifiers of any entity or entities related to the situation to be included in the record. The identifier(s) may be included into the portion by, for instance, typing them into a text box, selecting them from a menu, or selecting them by dragging their graphical representation to the portion through, for example, a computer mouse action. The identifiers may also appear in the portion for selection based on the entities shown in the screen image. For instance, if the screen image contains 10 entities, all the identifiers of the 10 entities would show up in the portion for user selection. The user can choose the related entities from all the identifiers appearing in the portion.

After the identifier(s) of the related entity or entities is/are included, the program for record creation may be configured to instruct the processing unit of the apparatus to, for instance, enable displaying of a note associated with the created record on the screen image or other screen image(s). The note can be deemed as an indicator of the created record. The note may be displayed as an attachment located at the location of or adjacent to the related entities present in the screen image or those other screen image(s). The note may appear as a small selectable icon with respect to the size of the entities as shown in the screen image or the other screen image(s). It may be located adjacent to the entity and all other entities having the same function found in other screen images. It is appreciated that the note may be selected to display the created record in the same or similar form as the record entry screen image, or be selected to be deleted along with the created record. Alternatively, the note may be created after the created record is associated with the selected point and saved at step 312.

The text entered into the record entry screen image and the selection(s) made via the selectable object(s)/widget(s) in the record entry screen image constitute the input.

The input is entered into the record entry screen image at step 310.

At step 312, the record as created on the record entry screen image is saved i.e. stored in a memory. The created record is also associated with the selected point so as to enable access to the record from the selected point from the screen image, or other screen images if the selected point is found in those screen images, and to enable the record to provide access to the screen image containing the selected point. The selected point can be located in another spot in other screen images and need not be at the same spot on the screen image where it is selected. It is appreciated that such association can be formed by having suitable source code. It is also appreciated that the other screen images could be displayed in the display device or another display device in the case where the apparatus is connected to a computer network. Furthermore, it could be said that the related entity or entities listed in the created record are, as a result of the association between the created record and the selected point, associated with the selected point as well.

After step 312, a predefined event is activated based on the input of the created record at step 314. The predefined event may be defined by source code that would execute based on the input. For instance, if the input contains a user selection to indicate that the strange situation requires immediate attention by certain people or immediate action from certain device(s), for example, in the case where a level of high importance is selected, the source code upon execution would send a message to one or more devices held or used by those people, or to the device(s) to take action. The message could be an email, a text message, a command or instruction to a device to take action, and the like. It is appreciated that the predefined event may also be set to activate just before the record is saved. The source code may be regarded as a handler. After its creation, the handler may require registration with a central network computer or server for it to take effect i.e. to activate the event.

The method 300 ends at step 316 after step 314.

An example illustrating the method 300 is as follows.

A user accesses an equipment scheduling screen image having a Gantt chart. The equipment scheduling screen image is displayed in a display device connected to a computer. The user identifies overloading of equipment from the Gantt chart. One device has been wrongly scheduled to be used by two separate tasks simultaneously. In this case, the tasks are the entities in the equipment scheduling screen image. Equipment relief can be provided if one of the tasks is delayed until the other task finishes the usage of the device. The user thus right clicks at i.e. selects a point of an equipment widget available on the equipment scheduling screen image to create a record. The equipment widget is considered to be an object in the Gantt chart.

The record entry screen image then appears and the user inputs a record header e.g. “Equipment Overloading”, a brief description of the situation e.g. “Device X is scheduled for use simultaneously by task A and task B”, and selects through e.g. a drop down menu, the level of importance of the record as ‘High importance’. A graphical representation linked to ‘High importance’ that is containing a colour such as red may be displayed in the record entry screen image.

The user also selects the identifiers of the two related tasks, which automatically appear in the record entry screen image after the user call up the equipment widget by “right clicking it” using a computer mouse with left and right buttons. In this case, all identifiers on the screen image are made to automatically appear in the record entry screen image upon the user clicking the equipment widget. This makes it convenient for the user to select the related identifiers, which in this case are the identifiers of the two related tasks.

After selecting the related identifiers, the record is deemed as created. The user then clicks an “OK” button available on the record entry screen image to save the created record and to associate the created record with the equipment widget.

After the record is saved, as the level of importance is ‘High importance’ and the identifiers of the two tasks had been previously tagged, tied or linked to electronic accounts belonging to two respective employees C and D, a predefined event is activated according to the identifiers and the level of importance recorded in the record. In this case, the predefined event is the sending of a High importance email, which contains the record header and the brief description, to devices held or used by employees C and D to inform them of the error in the equipment scheduling.

In addition, after the record is associated with the equipment widget and saved, a note would be created. In this case, the note appears as a small selectable icon with respect to the size of the equipment widget. It is located adjacent to the equipment widget and all other equipment widget having the same function found in other screen images. The note is selectable to display the created record in the same or similar form as the record entry screen image that was used to create the record, or selectable to be deleted along with the created record.

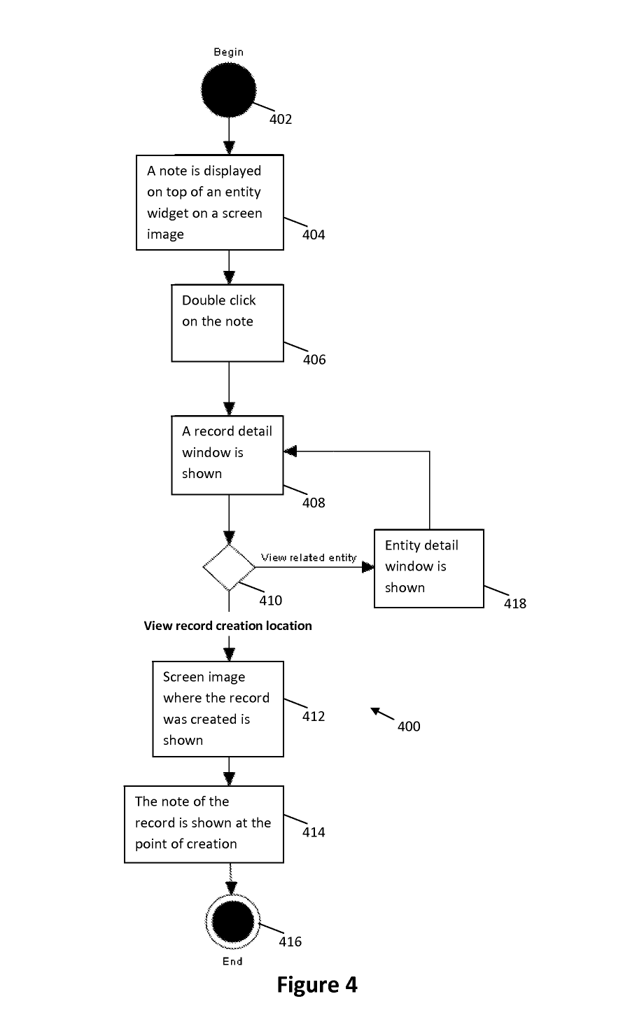

FIG. 4 shows a method 400 illustrating how the note described herein is utilised.

At step 402, the method 400 begins.

At step 404, a user is browsing a screen image (i.e. a second screen image) in a display device, which is not the screen image (i.e. first screen image) containing a selected point where its associated record is created by the method 300 in FIG. 3. The display device is connected to an apparatus such as a desktop computer. The screen image browsed contains a few entities represented in the form of widgets. One of the widgets has the note located on top it. In this case, the note happens to be one created for the record that is associated with the selected point.

As the note is created for the record created by the method 300 in FIG. 3, it can be selected to gain access to the record. At step 406, the user selects the note by in this case “double clicking it” using a computer mouse with left and right buttons that is connected to the apparatus.

After step 406, a record detail window i.e. a displayed record is shown at step 408. In this case, the record detail window overlaps a portion of the screen image. The record detail window contains input of the record entered via the record entry screen image of the method 300 in FIG. 3. The record detail window may resemble the record entry screen image.

In this case, the record detail window contains a portion containing identifiers of all entities related to the situation recorded in the record. The portion includes the identifier of the entity found in the screen image browsed by the user.

The record detail window further contains a first button and a second button. The first button is selectable to display the screen image containing the point where the record was created i.e. the record creation location. The second button is selectable to display an entity detail window containing details of one or more entities with its or their identifiers selected in the portion. Alternatively, on selecting the second button, more than one entity detail window may be displayed for more than one respective entity with their respective identifiers selected in the portion. In yet another example, only one identifier can be selected in the portion at one time.

Step 410 is a decision point by the user whether to view details of one or more entities related to the situation recorded in the record or to view the record creation location.

In this case, only one identifier can be selected in the portion at one time. To view details of a related entity, the identifier of the entity in the portion is first selected. Thereafter, the second button is selected to display an entity detail window relating to the entity of the selected identifier in the portion at step 418.

By selecting the first button, the screen image where the record was created is shown at step 412.

At step 414, the screen image where the record was created shows a note indicative of the record. The note indicative of the record is located at the select point associated with the record created using the method 300 in FIG. 3.

The method 400 ends at step 416 after step 414.

An example illustrating the method 400 is as follows.

A user browses a screen image with a Gantt chart. The screen image is displayed in a display device connected to a computer. The user sees a note above the widgets belonging to two tasks. By simply inspecting the Gantt chart, it may not be possible to identify that there is overloading of equipment i.e. one device is scheduled to run simultaneously in two separate tasks.

However, with the note present, the user can select the note to open up a record detail window containing information of the record linked to the note. The user can understand from the description in the record detail window that there is a problem of overloading of equipment.

Furthermore, by clicking on a first button in the record detail window, the user can navigate to an equipment screen image where the record linked to the note is created. The note will advantageously appear at the point, in this case, a point of an equipment widget in the equipment screen image, where the record linked to the note is located.

In addition, by first selecting an identifier of an entity, in this case, an equipment widget of the device that is wrongly scheduled, and then clicking a second button in the record detail window, an entity detail window is advantageously shown to provide detailed information of the device. The identifier of the equipment widget of the device is located in a portion of the record detail window.

Another example illustrating the use of method 300 in FIG. 3 and method 400 is as follows.

In a refinery company with staff working on different time shifts, shift reports prepared by the staff working on the shifts are very important. Through the shift reports, all operations that have occurred can be tracked for maintenance and management purposes.

For instance, in an electronic shift report, there may be an operation indicated in the report that needs to be highlighted to staff working in a later shift. The author or the reviewer of the shift report may create a record using the method 300 of FIG. 3 on a screen image showing a part of the shift report containing a situation that needs to be highlighted to the staff on the later shift.

A staff on the later shift can firstly be informed via email about the situation to be highlighted. This could be done by step 314 in FIG. 3, which activates a predefined event after the created record is saved. In this case, the event is to send emails to the relevant staff on the later shift.

Thereafter, by accessing any screen image of the shift report containing the entity or entities related to the situation, the staff on later shift can access the record details through the notes created for the record, which are attached to the entity or entities found in the screen image accessed.

If necessary, the related entity details can be viewed by the staff on a later shift from the record detail window of the record.

In this manner, a shift report containing many screen images and entities can be easily reviewed by all staff through the use of the notes created. With easier access to outstanding situations and fast alerting via step 314 of FIG. 3, parameters affecting the refinery process such as process time, staffing for shifts, temperature, and weather can be better managed.

It is appreciated that records may be created for negative, neutral or positive usage. For instance, if an OPC (OLE for Process Control; OLE means ‘Object Linking and Embedding’) event failed due to human error. A user can raise a “heads-up” (i.e. high importance) record and alert a staff on a later shift using the method 300 in FIG. 3. If an operator wants a superior to take a look at an activity, the operator may create a record using the method 300 in FIG. 3 in his/her electronic report and alert the superior. If a superior wants to commend a subordinate for a job well done, the superior may create a record using the method 300 in FIG. 3, which can be easily accessed by the subordinate.

A further feature may be provided to the apparatus referred in the description described with reference to method 300 in FIG. 3.

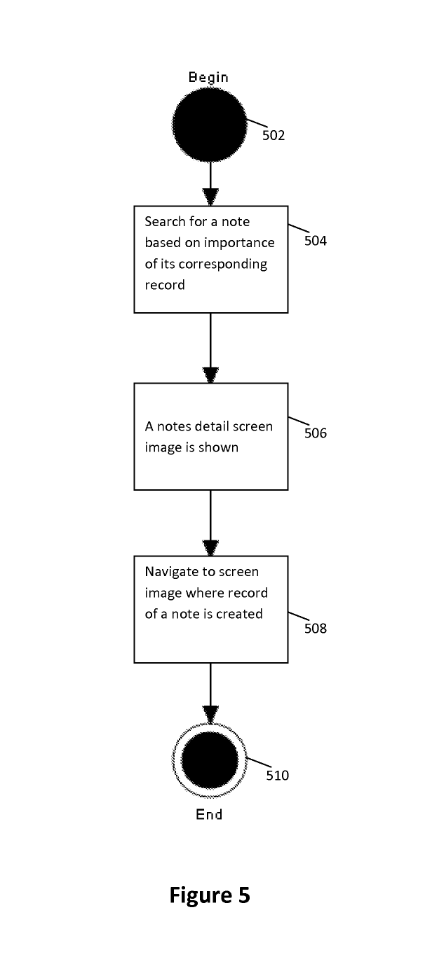

For instance, with reference to FIG. 5, a method 500 for searching a note by level of importance may be provided. The note here refers to the same type of note that is described with reference to FIGS. 3 and 4, and the various examples provided.

At step 502, the method 500 begins.

A user searches for a note previously created by the method 300 in FIG. 3 at step 504 on a computer having a display device. The search is performed using a search engine and is based on a level of importance associated with the record linked to the note. To perform the search, a keyword for a specific level of importance is entered into the search engine to specify the level of importance to be based on for the search. The search engine is represented in the form of a GUI shown in the display device.

The search results would be returned in the form of a notes detail screen image containing all the notes with corresponding records having the specified level of importance at step 506. The notes detail screen image contains links to all the note(s) with the specified level of importance.

By selecting a link to a note listed in the notes detail screen image, the user can navigate to a screen image containing a point where the record of the note was created at step 508.

The method 500 ends at step 510 after step 508.

An example to illustrate method 500 is one where a user searches for notes having importance set to ‘High Importance’. Advantageously, from the notes detail screen image, a user can efficiently navigate to an equipment screen image showing an equipment widget containing the point where the record of a note with ‘High Importance’ is created.

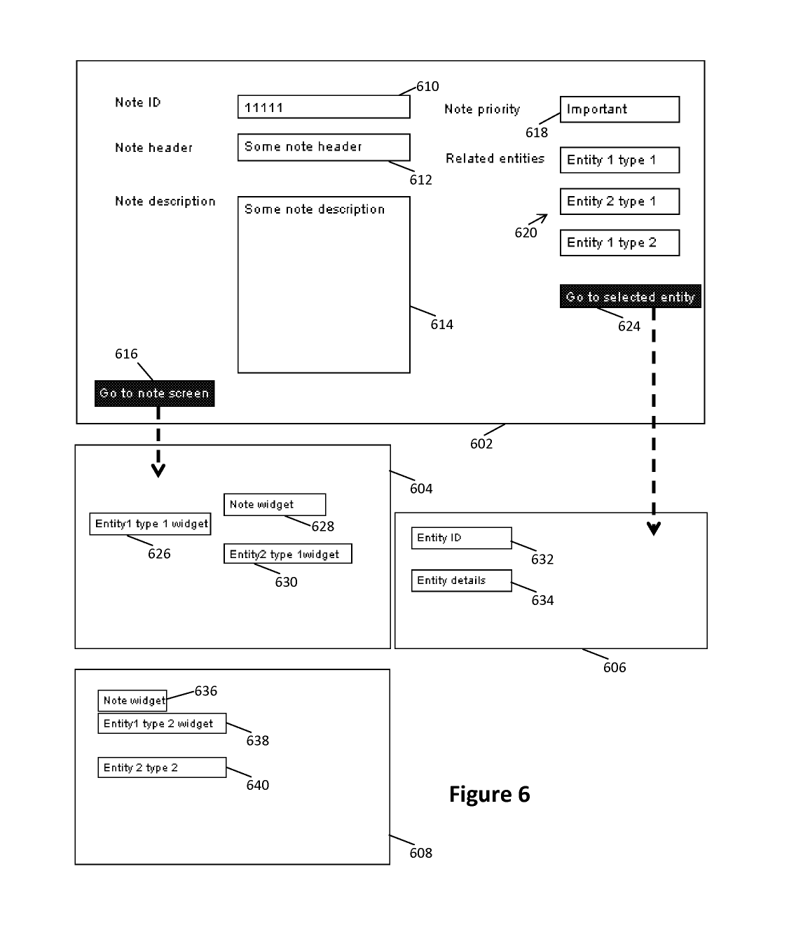

FIG. 6 shows four screen images or windows (a screen image covers a window), namely, a record detail window 602, which has been previously described with reference to FIG. 4, a screen image 604 showing a note widget 628 located at a point where the record linked to the note widget 628 is created, an entity detail window 606, which has been previously described with reference to FIG. 4, and a screen image 608 that is not the screen image where a record originates but contains a note widget 636 linked to the record. Screen images 604 and 608 have also been previously described with reference to other figures and in the various examples provided.

The record detail window 602 is essentially a displayed record and it contains a serial number box 610 containing a serial number i.e. a Note identifier (ID) for a record, a header box 612 containing a header, a description box 614 containing a description or explanation of a situation of interest linked to the record and a priority box 618 containing a level of importance associated with the record. The record detail window 602 further contains a first button 616 and a second button 624. It is appreciated that a button herein described is also a form of trigger. The first button 616 is selectable to display the screen image 604. The second button 624 is selectable to display the screen image 606. The record detail window 602 also includes a portion 620 having, in this case, three identifiers of three entities previously selected to be related to the situation of the record.

Other than the note widget 628, which is located at a point where the record linked to the note widget 628 is created, the screen image 604 contains two other entity widgets 626 and 630.

The entity detail window 606 contains an entity identifier box 632 containing an identifier i.e. Entity ID of the entity of the entity detail window 606, and an entity details box 634 containing detailed information of the entity of the entity detail window 606.

The screen image 608 contains a note widget 636 linked to the record shown in screen image 602. The note widget 636 is attached to an entity widget 638 with its identifier listed in the record shown in screen image 602. There is another entity widget 640 present in screen image 608 that is not listed in the record shown in screen image 602.

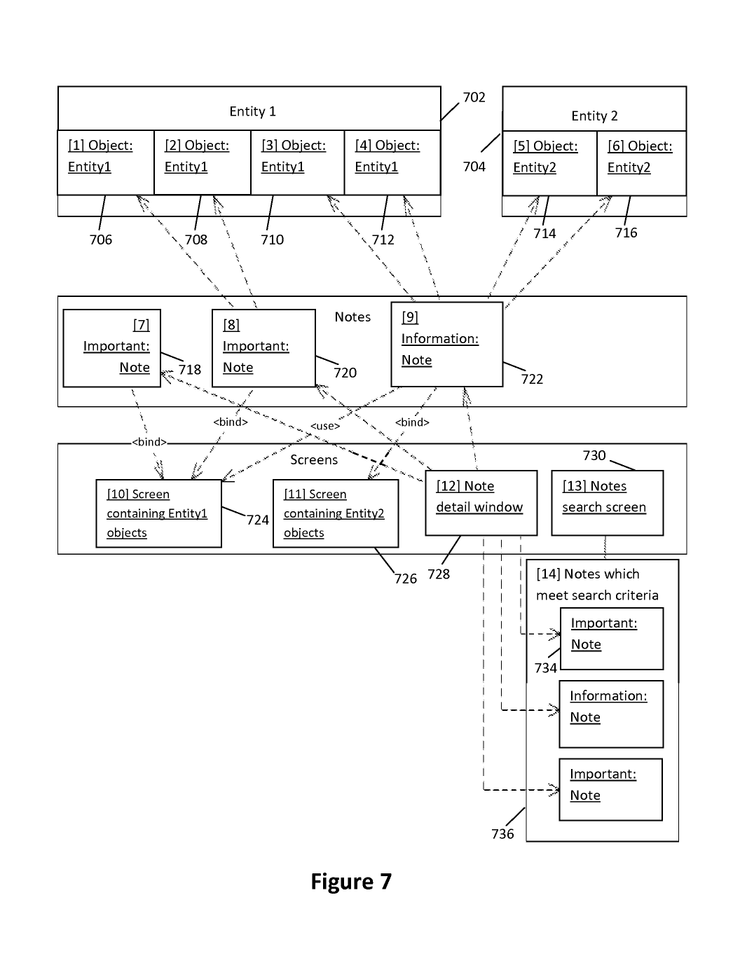

FIG. 7 illustrates interaction between components of the methods and apparatus described herein with reference to the other figures.

FIG. 7 shows two entities, entity one 702 and entity two 704. Entity one 702 has four objects, 706, 708, 710 and 712 related to it. Entity two 704 has two objects 714 and 716 related to it.

FIG. 7 also shows three notes 718, 720 and 722. Two of the notes 718 and 720 have records with important statuses and one of the notes 722 does not have an important status. The note 722 just contains general information. Furthermore, the record of note 720 contains identifiers of objects 706 and 708 and the record of note 722 contains identifiers of objects 710, 712, 714 and 716.

Also found in FIG. 7 are four screen images, namely, a screen image 724 containing all objects of entity 702, a screen image 726 containing all objects of entity two 704, a note or record detail window 728 that contains input of the record of note 722, a notes search screen image 730 resembling a search engine GUI for entering search criteria to search for notes, and a search result screen image 736 containing all notes 734 (in this case, three are shown in FIG. 7) meeting the search criteria.

Note 718 and 720 are considered to be bounded to screen image 724 as their records are created on screen image 724. Note 722 is considered to be bounded to screen image 726 as its corresponding record is created on screen image 726. Note 722 is considered to be used by screen image 724 because it is found in screen image 724 but has its record created in screen image 726.

FIG. 7 generally illustrates the following points.

A note of a record can be placed on any screen image and be related to any entity represented by a widget on that screen image. Reference is made to screen image 724 and 726.

The record will be associated with its screen image and point of creation. Reference is made to note 722, which is bounded to screen image 726, and at the same time shown as an attachment to related objects of entity one 702 present in screen image 724.

A note can also link to entities, which are not presented on a screen image containing the note, as long as the record includes the entities. Reference is made to screen image 726 containing only objects of entity two 704 and to note 722, which also contains objects of entity one 702.

A note can be placed on a specific location on a screen image without relation to any of the entities. This point is better illustrated in screen images 604 and 608 of FIG. 6.

Notes can have a higher level of importance or lower level of importance. The lower level of importance can just be providing information and not requiring more immediate user action. Reference is made to the status of notes 718, 720, 722 and those of notes 734.

By opening a note detail window, a user can navigate to the details screen image of every related entity. This is better illustrated by the button 624 and the screen image 606 in FIG. 6.

If an entity widget in a screen image has its identifier recorded in a record of a note and the record was created on another screen image, the note will be attached to the entity widget. This is better illustrated in screen images 604 and 608 of FIG. 6.

Selecting a note contained in a screen image will open a note detail window containing links to details of other related entities of the record of the note, and the screen image and point of creation where the record of a note was previously created. Reference is made to the note detail window 728, and the notes 718 and 720, and 722 that are bounded to the screen images 724 and 726 respectively.

With reference to the notes search screen image 730, notes can be searched by different criteria relating to the details inputted in the corresponding records of the notes.

With reference to the search result screen image 736 and the note or record detail window 728, selecting a note 734 in the form of a note widget in the search result screen image 736 will open a note or record detail window 728 containing details of the record of the note 734.

Examples of the method and apparatus for creating a note as described herein with reference to the figures may have the following advantages.

A record can be created and displayed on any screen image, and be accessible through a note from every screen image containing the entities related to the record. Hence, there is no need to browse through a lot of screen images aimlessly in search of information or references, e.g. entity information, of a situation recorded in a record.

Since a note can be related to any entity on any screen image, the record of the note will become a repository of direct links to the screen images and entities involved in particular a situation of interest.

A record would contain a trigger to provide direct navigation to the screen image containing the point where the record was created. A note widget would be presented at the precise point on the screen image that is selected for creating the record.

A note can be created and placed on any selected point of any screen image. This will advantageously preserve the integrity of the created note and its corresponding record, and help to identify the situation (s) triggering the note and its corresponding record to be created.

By viewing a screen image where a user is sure that a note linked to a particular entity exists, the user can immediately be aware of the existence of a strange situation for the particular entity. This is better than calling out a list of all notes to look for one note linked to the particular entity.

When a record containing involved entities is saved, one or more predefined event handlers can receive input of the record and retrieve information related to the entities having their identifiers saved in the record. Based on predefined logic, each of the one or more handlers can decide which action or actions are necessary to execute. In this manner, the user may not have to find the solution for a particular situation and manually carry out the actions linked to the solution. Instead, the solution can be automatically carried out by the predefined handler's logic. Advantageously, the user only has to identify situations.

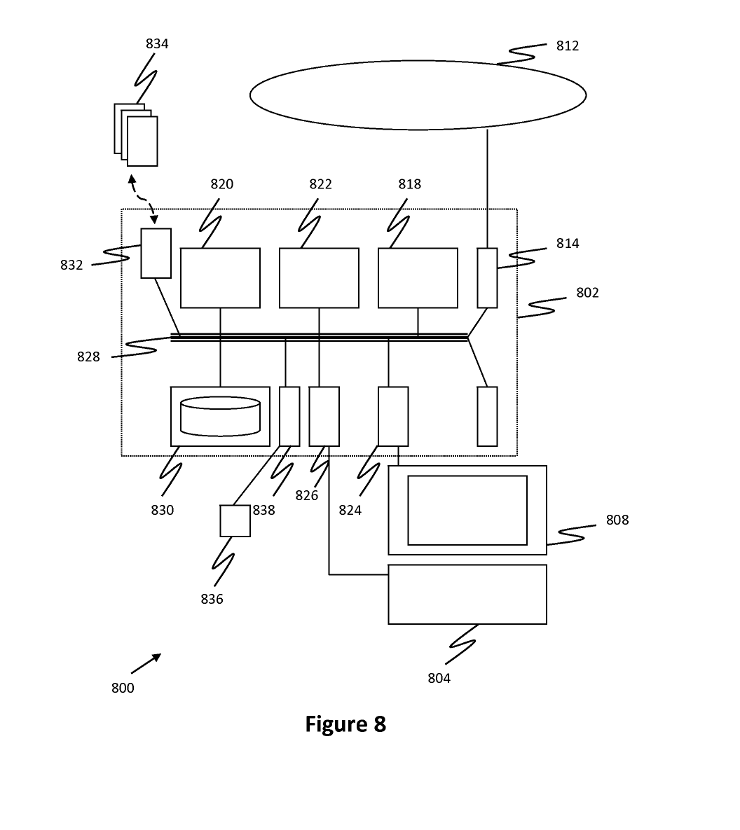

The apparatus described with reference to FIG. 3 may be a device 800, schematically shown in FIG. 8. There may be provided software, such as one or more computer programs being executed within the device 800, and instructing the device 800 to run the steps herein described with reference to FIGS. 3, 4 and 5, enable the interaction as illustrated in FIG. 7 and for displaying screenshots such as those illustrated in FIG. 6.

The device 800 comprises a processing unit 802 for processing the one or more computer programs, and includes input modules such as a computer mouse 836, keyboard/keypad 804, and/or a plurality of output devices such as a display device 808.

The processing unit 802 may be connected to a computer network 812 via a suitable transceiver device 814 (i.e. a network interface), to enable access to e.g. the Internet or other network systems such as a wired Local Area Network (LAN) or Wide Area Network (WAN). The processing unit 802 may also be connected to one or more external wireless communication enabled devices 834 via a suitable wireless transceiver device 832 e.g. a WiFi transceiver, Bluetooth module, Mobile telecommunication transceiver suitable for Global System for Mobile Communication (GSM), 3G, 3.5G, 4G telecommunication systems, or the like.

The processing unit 802 may include a processor 818, a Random Access Memory (RAM) 820 and a Read Only Memory (ROM) 822. The processing unit 802 may also includes a number of Input/Output (I/O) interfaces, for example I/O interface 838 to the computer mouse 836, I/O interface 824 to the display device 808, and I/O interface 826 to the keyboard/keypad 804.

The components of the processing unit 802 typically communicate via an interconnected bus 828 and in a manner known to the person skilled in the relevant art.

The computer programs may further include one or more software applications for e.g. instant messaging platform, audio/video playback, internet accessibility, operating the device 800 (i.e. operating system), network security, file accessibility, database management, which are applications typically equipped on a desktop or portable computer. The computer programs may be supplied to the user of the device 800 encoded on a data storage medium such as a CD-ROM, on a flash memory carrier or a Hard Disk Drive, and are to be read using a corresponding data storage medium drive of a data storage device 830. Such application programs may also be downloaded from the computer network 812. The application programs are read and controlled in its execution by the processor 818. Intermediate storage of program data may be accomplished using RAM 820.

Furthermore, one or more of the steps of the computer programs may be performed in parallel rather than sequentially. One or more of the computer programs may be stored on any machine- or computer-readable medium. The machine- or computer-readable medium may include storage devices such as magnetic or optical disks, memory chips, or other storage devices suitable for interfacing with a general purpose computer. The machine- or computer-readable medium may also include a hard-wired medium such as exemplified in the Internet system, or wireless medium such as exemplified in the Wireless LAN (WLAN) system and the like. The computer program when loaded and executed on such a general-purpose computer effectively results in an apparatus that implements the steps of the computing methods in examples herein described.

It is appreciated that in some instances of the present description, ‘note’ and ‘note widget’ are used interchangeably. The same goes for ‘entity’ and ‘entity widget’.

Many modifications can be made to the method and apparatus for creating a record by those skilled in the art having the understanding of the above described disclosure together with the drawings. Therefore, it is to be understood that the method and apparatus for creating a record is not to be limited to the above description contained herein only.

1. A method for creating a record, the method comprising:
selecting a point on a screen image, the screen image being displayable on a display device;
obtaining input through an interface;
creating a record for containing the input;
associating the created record with the selected point;
activating a predefined event based on the input of the created record; and
storing the created record in a memory.

2. The method as claimed in claim 1, the method comprising:
creating a note for displaying on a second screen image, and the note being selectable for displaying the created record.

3. The method as claimed in claim 2, wherein the second screen image is the screen image, and the created note is for displaying at the selected point on the screen image.

4. The method as claimed in claim 2, wherein the second screen image being displayable on the display device or another display device.

5. The method as claimed in claim 2, the note being displayed as an attachment to an entity associated with the selected point.

6. The method as claimed in claim 2, the method comprising:
displaying the screen image through a trigger in the displayed record.

7. The method as claimed in claim 2, the method comprising:
displaying information of an entity associated with the created record through a trigger in the displayed record.

8. The method as claimed in claim 1, wherein obtaining input from the interface comprising obtaining a level of importance associated with the created record.

9. The method as claimed in claim 2, the method comprising:
searching for the created note based on a level of importance associated with the created record using a search engine.

10. The method as claimed in claim 2, the method comprising:
displaying the created record by selecting the created note from a screen image comprising one or more notes.

11. The method as claimed in claim 1, wherein activating a predefined event based on the input of the created record comprising sending a message electronically to one or more devices.

12. The method as claimed in claim 1, wherein the selected point is an object in a Gantt chart.

13. An apparatus for creating a record, the apparatus comprising:
a display device for displaying a screen image;
an interface for obtaining input; and
a processing unit configured for
enabling selection of a point on the screen image,
creating a record for containing the input,
associating the created record with the point selected on the screen image,
activating a predefined event based on the input of the created record; and
storing the created record in a memory.

14. The apparatus as claimed in claim 13, the processing unit being configured for
creating a note for displaying on a second screen image, and the note being selectable for displaying the created record.

15. The apparatus as claimed in claim 14, wherein the second screen image is the screen image, and the created note is for displaying at the selected point on the screen image.

16. The apparatus as claimed in claim 14, wherein the second screen image being displayable on the display device or another display device.

17. The apparatus as claimed in claim 14, the note being displayed as an attachment to an entity associated with the selected point.

18. The apparatus as claimed in claim 14, the created record comprising a trigger for displaying the screen image.

19. The apparatus as claimed in claim 14, the created record comprising a trigger for displaying information of an entity associated with the created record.

20. The apparatus as claimed in claim 13, the input comprising a level of importance associated with the created record.

21. The apparatus as claimed in claim 14, the processing unit being configured for
enabling searching for the created note based on a level of importance associated with the created record using a search engine.

22. The apparatus as claimed in claim 14, the processing unit being configured for
enabling display of the created record through selection of the created note from a screen image comprising one or more notes.

23. The apparatus as claimed in claim 13, the predefined event comprising sending a message electronically to one or more devices.

24. The apparatus as claimed in claim 13, wherein the selected point is an object in a Gantt chart.

25. A machine-readable medium, having stored thereon machine-readable instructions for executing, in a machine, a method for creating a record, the method comprising:
selecting a point on a screen image, the screen image being displayable on a display device;
obtaining input through an interface;
creating a record for containing the input;
associating the created record with the selected point;
activating a predefined event based on the input of the created record; and
storing the created record in a memory.
